(19) United States
(12) Patent Application Publication
(10) Pub. No.: US 2024/0282985 A1
(43) Pub. Date: Aug. 22, 2024

(54) PRESSURE SENSOR CONTAINING ICE MITIGATING FEATURE AND ELECTROCHEMICAL SYSTEM USING THE SAME

(71) Applicant: BLOOM ENERGY CORPORATION, San Jose, CA (US)

(72) Inventor: Shannon BELL, San Jose, CA (US)

(21) Appl. No.: 18/442,505

(22) Filed: Feb. 15, 2024

Related U.S. Application Data
(60) Provisional application No. 63/486,173, filed on Feb. 21, 2023.

(51) Int. Cl. H01M 8/04089; G01L 7/08; H01M 8/04007; H01M 8/04119; H01M 8/04223

(52) U.S. Cl. CPC H01M 8/04104; G01L 7/08; H01M 8/04179; H01M 8/04067; H01M 8/04253

(57) ABSTRACT

A pressure sensor includes a transducer portion containing a pressure sensing diaphragm, and a connecting portion having a first end in fluid communication with the transducer portion and a second end located opposite to the first end. The connecting portion includes a bore having an outlet and a stepped inlet. The outlet is located closer to the first end than the stepped inlet. The stepped inlet includes a first surface having a gas opening and a second surface having a water opening. The first surface is located closer to the first end than the second surface.

### FIELD

Aspects of the present invention relate to pressure sensors, and more particularly, to fuel cell and electrolyzer systems including the pressure sensors.

### BACKGROUND

Various systems, such as fuel cell and electrolyzer systems, use pressure sensors to monitor and control one or more process streams. The pressure sensors may comprise pressure transducers which include a diaphragm pressure sensing element.

### SUMMARY

According to various embodiments, a pressure sensor includes a transducer portion containing a pressure sensing diaphragm, and a connecting portion having a first end in fluid communication with the transducer portion and a second end located opposite to the first end. The connecting portion includes a bore having an outlet and a stepped inlet. The outlet is located closer to the first end than the stepped inlet. The stepped inlet includes a first surface having a gas opening and a second surface having a water opening. The first surface is located closer to the first end than the second surface.

### BRIEF DESCRIPTION OF THE DRAWINGS

The accompanying drawings, which are incorporated herein and constitute part of this specification, illustrate example embodiments of the invention, and together with the general description given above and the detailed description given below, serve to explain the features of the invention.

FIG. 1 is a schematic of a fuel cell system, according to various embodiments of the present disclosure.

FIG. 2A is perspective view of a pressure sensor, according to various embodiments of the present disclosure.

FIG. 2B is a side cross-sectional view of the pressure sensor of FIG. 2A.

FIG. 2C is a close-up, side cross-sectional view of portion C of the pressure sensor of FIG. 2B.

FIG. 2D is a close-up, side cross-sectional view of the pressure sensor of FIGS. 2A and 2B.

FIG. 2E is a cut-away perspective view of the pressure sensor of FIGS. 2A, 2B and 2D.

### DETAILED DESCRIPTION

The various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the invention or the claims.

Electrochemical systems include fuel cell systems, such as solid oxide fuel cell (SOFC) systems, and electrolyzer systems, such as solid oxide electrolyzer (SOEC) systems.

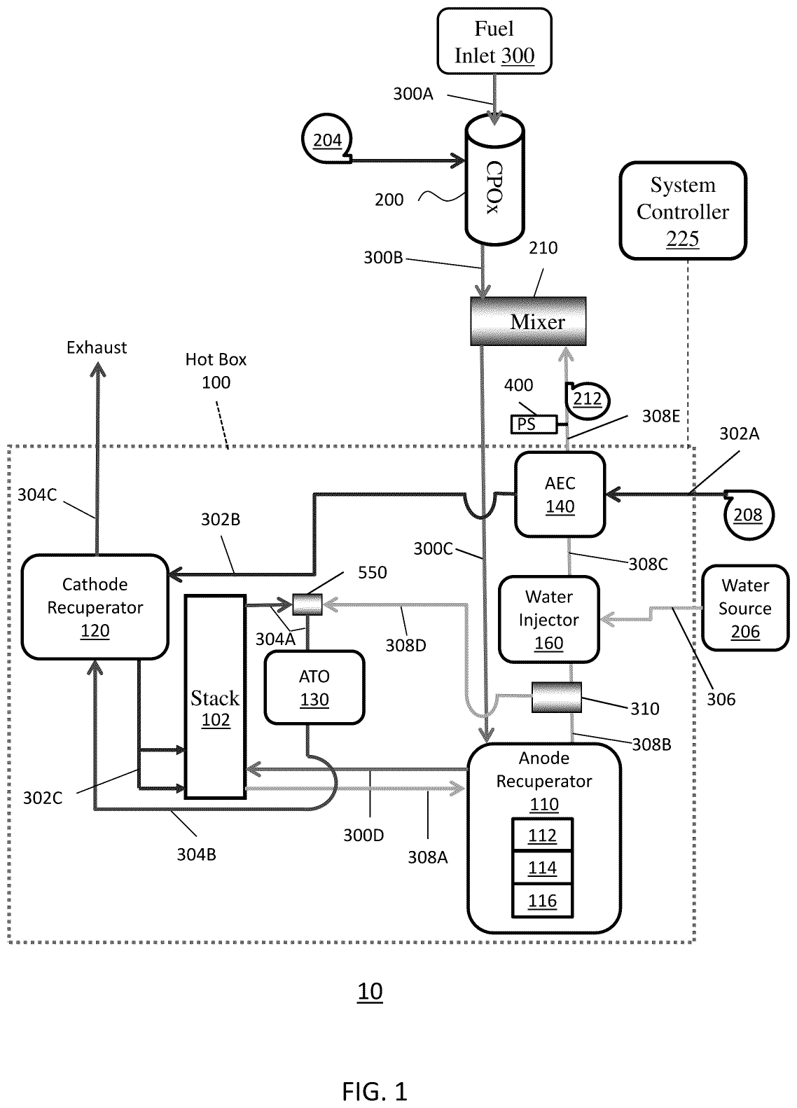

FIG. 1 is a schematic representation of a SOFC system 10, according to various embodiments of the present disclosure. Referring to FIG. 1, the system 10 includes a hotbox 100 and various components disposed therein or adjacent thereto. The hot box 100 may contain fuel cell stacks 102, such as a solid oxide fuel cell stacks containing alternating fuel cells and interconnects. One solid oxide fuel cell of the stack contains a ceramic electrolyte, such as yttria stabilized zirconia (YSZ), scandia stabilized zirconia (SSZ), scandia and ceria stabilized zirconia or scandia, yttria and ceria stabilized zirconia, an anode electrode, such as a nickel-YSZ, a nickel-SSZ or nickel-doped ceria cermet, and a cathode electrode, such as lanthanum strontium manganite (LSM). The interconnects may be metal alloy interconnects, such as chromium-iron alloy interconnects. The stacks 102 may be arranged over each other in a plurality of columns.

The hot box 100 may also contain an anode recuperator heat exchanger 110, a cathode recuperator heat exchanger 120, an anode tail gas oxidizer (ATO) 130, an anode exhaust cooler heat exchanger 140, a splitter 310, a vortex generator 550, and a water injector 160. The system 10 may also include a catalytic partial oxidation (CPOx) reactor 200, a mixer 210, a CPOx blower 204 (e.g., air blower), a system blower 208 (e.g., air blower), and an anode recycle blower 212, which may be disposed outside of the hotbox 100. However, the present disclosure is not limited to any particular location for each of the components with respect to the hotbox 100.

The CPOx reactor 200 receives a fuel inlet stream from a fuel inlet 300, through fuel conduit 300A. The fuel inlet 300 may be a fuel tank or a utility natural gas line including a valve to control an amount of fuel provided to the CPOx reactor 200. The CPOx blower 204 may provide air to the CPOx reactor 202 during system start-up. The fuel and/or air may be provided to the mixer 210 by fuel conduit 300B. Fuel flows from the mixer 210 to the anode recuperator 110 through fuel conduit 300C. The fuel is heated in the anode recuperator 110 by a portion of the fuel exhaust and the fuel then flows from the anode recuperator 110 to the stack 102 through fuel conduit 300D.

The main air blower 208 may be configured to provide an air stream (e.g., air inlet stream) to the anode exhaust cooler 140 through air conduit 302A. Air flows from the anode exhaust cooler 140 to the cathode recuperator 120 through air conduit 302B. The air is heated by the ATO exhaust in the cathode recuperator 120. The air flows from the cathode recuperator 120 to the stack 102 through air conduit 302C.

An anode exhaust stream generated in the stack 102 is provided to the anode recuperator 110 through the anode exhaust conduit 308. The anode exhaust conduit 308 may comprise several pipes or branches, such as the anode exhaust conduit branch 308A. The anode exhaust may contain unreacted fuel and may also be referred to herein as fuel exhaust. The anode exhaust may be provided from the anode recuperator 110 to the splitter 310 by anode exhaust conduit branch 308B. A first portion of the anode exhaust may be provided from the splitter 310 to the anode exhaust cooler 140 through the water injector 160 and the anode exhaust conduit branch 308C. A second portion of the anode exhaust is provided from the splitter 310 to the ATO 130 through the anode exhaust conduit branch 308D. The first portion of the anode exhaust heats the air inlet stream in the anode exhaust cooler 140 and may then be provided from the anode exhaust cooler 140 to the mixer 210 through the anode exhaust conduit branch 308E. The anode recycle blower 212 may be configured to move anode exhaust though anode exhaust conduit branch 308E, as discussed below.

Cathode exhaust generated in the stack 102 flows to the ATO 130 through exhaust conduit 304A. The vortex generator 550 may be disposed in exhaust conduit 304A and may be configured to swirl the cathode exhaust. The anode exhaust conduit branch 308D may be fluidly connected to the vortex generator 550 or to the cathode exhaust conduit 304A or the ATO 130 downstream of the vortex generator 550. The swirled cathode exhaust may mix with the second portion of the anode exhaust provided by the splitter 310 before being provided to the ATO 130. The mixture may be oxidized in the ATO 130 to generate an ATO exhaust. The ATO exhaust flows from the ATO 130 to the cathode recuperator 120 through exhaust conduit 304B. Exhaust flows from the cathode recuperator and out of the hotbox 100 through exhaust conduit 304C.

Water flows from a water source 206, such as a water tank or a water pipe, to the water injector 160 through water conduit 306. The water injector 160 injects water directly into first portion of the anode exhaust provided in conduit branch 308C. Heat from the first portion of the anode exhaust (also referred to as a recycled anode exhaust stream) provided in exhaust conduit branch 308C vaporizes the water to generate steam. The steam mixes with the anode exhaust, and the resultant mixture is provided to the anode exhaust cooler 140. The mixture is then provided from the anode exhaust cooler 140 to the mixer 210 through the anode exhaust conduit branch 308E. The mixer 210 is configured to mix the steam and first portion of the anode exhaust with fresh fuel (i.e., fuel inlet stream). This humidified fuel mixture may then be heated in the anode recuperator 110 by the anode exhaust, before being provided to the stack 102. The system 10 may also include one or more fuel reforming catalysts 112, 114, and 116 located inside and/or downstream of the anode recuperator 100. The reforming catalyst(s) reform the humidified fuel mixture before it is provided to the stack 102.

The system 10 contains one or more pressure sensors 400. For example, the pressure sensor(s) 400 may be located on the anode exhaust conduit 308, such as on the anode exhaust conduit branch 308E outside the hot box 100. The pressure sensor 400 may be located upstream or downstream of the blower 212. Alternatively, the pressure sensor(s) 400 may be located on other branches of the anode exhaust conduit 308 and/or on other conduits.

The system 10 may further a system controller 225 configured to control various elements of the system 10. The controller 225 may include a central processing unit configured to execute stored instructions. For example, the controller 225 may be configured to control fuel and/or air flow through the system 10, according to various sensor data. For example, the system controller 225 may use gas pressure data determined by the pressure sensor 400 to control the fuel and/or air flow through the system 10.

In the SOFC system, such as the SOFC system 10 described above, the fuel inlet stream may be humidified in order to facilitate fuel reformation reactions, such as steam reformation and water-gas shift reactions. In addition, during system startup, shutdown, and power grid interruption events, water may be added to a fuel inlet stream in order to prevent coking of system components such as catalysts. Such humidification is performed by vaporizing water in a steam generator containing corrugated tubing or by providing water from a water injector 160 configured to inject water directly into the anode exhaust recycle stream which provides heat to vaporize the water into steam and/or aerosolize the water into droplets small enough to be entrained in the anode exhaust stream. The anode exhaust recycle stream is recycled via the anode exhaust conduit 308 into the fuel inlet stream provided into the fuel cell stack 102, such that humidified fuel is provided to the fuel cells of the fuel cell stack 102.

In the SOEC system, the residual steam (i.e., water) that is not electrolyzed in the SOEC cells (i.e., which is not converted to oxygen and hydrogen) may be recycled back into the SOEC cells via a water recycle conduit.

The present inventor realized that if the electrochemical system is shut down and allowed to cool entirely, residual water (e.g., steam) may condense into liquid water inside the plumbing (e.g., in the anode exhaust conduit 308 of the SOFC system 10 or the water recycle conduit of the SOEC system) and inside the sensing cavity of the pressure sensors located in fluid communication with such plumbing. Due to the small cavity size of such sensors, surface tension prevents the liquid water from naturally draining by the force of gravity. If the condensed liquid water is allowed to freeze, then the captive water (i.e., ice) expands and applies excessive force on the thin sensing diaphragm in the pressure sensor. This may cause damage or deformation to the sensing diaphragm.

In one embodiment, the pressure sensor connecting portion (e.g., the connection fitting) of the pressure sensor includes separate gas inlet and water draining openings (i.e., ports) at different elevations to assist in draining the condensed liquid water from the sensing cavity in the pressure transducer portion of the pressure sensor. This configuration removes (i.e., drains) the water condensate that would normally be captive sensing cavity of the pressure sensor in the event of a loss of power. It does not require a power source to heat the pressure sensor to prevent freezing of the captive water condensate. Thus, ice formation at the sensing diaphragm in the pressure transducer portion of the pressure sensor may be reduced or avoided without using an external heater, which requires external power to operate. Thus, even in case of a loss of power, the sensing diaphragm is not damaged by ice formation.

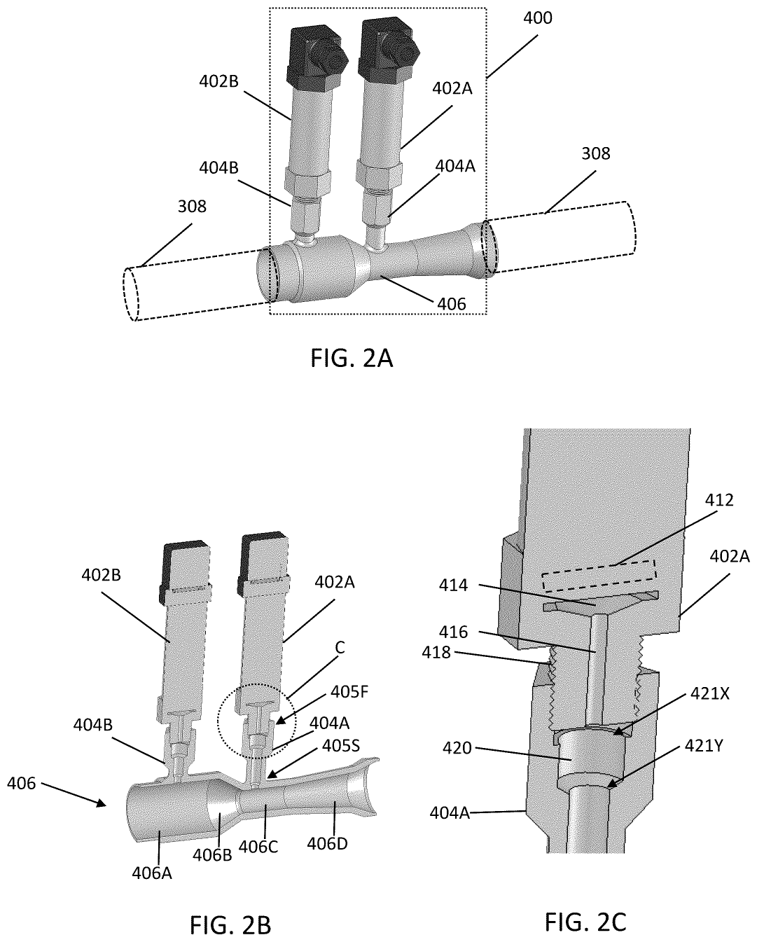

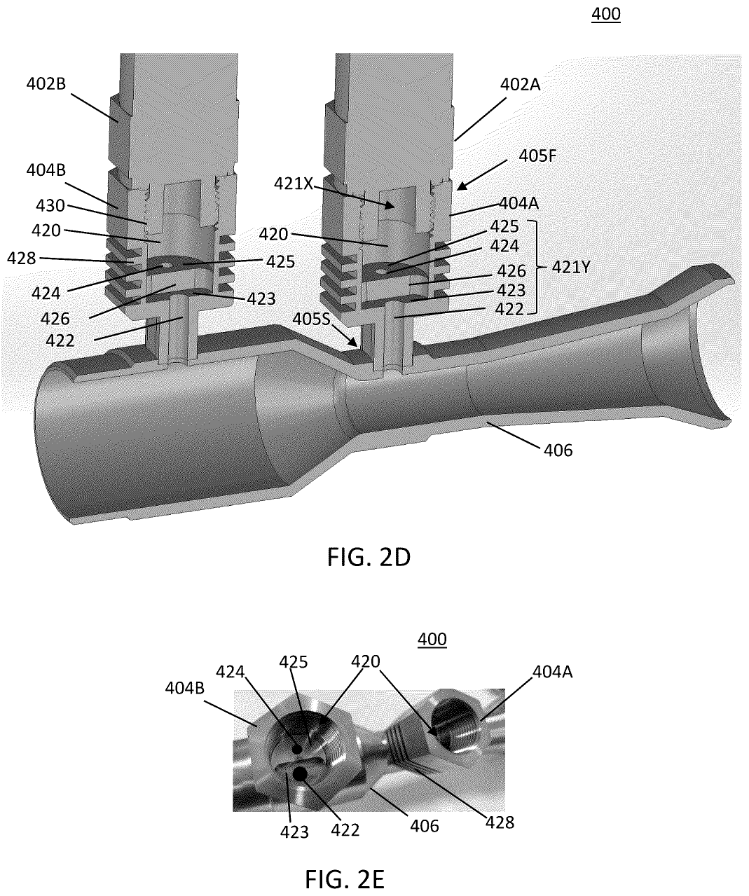

Referring to FIGS. 2A to 2E, a pressure sensor 400 includes a transducer portion 402A comprising a pressure sensing diaphragm 412, and a connecting portion (e.g., connection fitting portion) 404A having a first end 405F in fluid communication with the transducer portion 402A, and a second end 405S located opposite to the first end 405F. The connecting portion 404A comprises a bore 420 (e.g., an opening surrounded by one or more sidewalls) having an outlet 421X and a stepped inlet 421Y. The outlet 421X is located closer to the first end 405F than the stepped inlet 421Y. The stepped inlet 421Y comprises a first surface 425 having a gas opening (i.e., gas inlet opening) 424 and a second surface 423 having a water opening (i.e., water drainage opening) 422. The first surface 425 is located closer to the first end 405F than the second surface 423.

In other words, if the transducer portion 402A is located above the connecting portion 404A relative to the ground (i.e., relative to the direction of the force of gravity), then the second surface 425 is located above the first surface 423. Thus, the first surface 425 is located farther from the second end 405S than the second surface 423; and the second surface 423 is located farther from the first end 405F than the first surface 425. The outlet 421X is located farther from the second end 405S than the stepped inlet 421Y; and the stepped inlet 421Y is located farther from the first end 405F than the outlet 421X. In one embodiment, the stepped inlet 421Y further comprises a sidewall 426 which extends from the first surface 425 to the second surface 423 perpendicular to the first surface 425 and to the second surface 423.

The transducer portion 402A further comprises the sensing cavity 414 located adjacent to the pressure sensing diaphragm 412, and an inlet conduit 416 which fluidly couples the sensing cavity 414 to the bore 420 of the connecting portion 404A.

Since the connecting portion 404A contains two openings (422, 424) (i.e., two process media ports) which extend to different elevations (423, 425), the lower water opening 422 allows condensed water to drain back into the process media stream (e.g., into the SOFC anode exhaust stream or SOEC water recycle stream). The upper gas opening 424 allows fresh process gas (e.g., SOFC anode exhaust stream or SOEC steam from the water recycle stream) to enter the bore 420 and cause a pressure differential on the condensed water in the sensing cavity 414. This allows the condensed water to drain out of the sensing cavity 414 via conduit 416, bore 420 and lower water opening 422 into the process media stream. Without the upper gas opening 424 which provides fresh gas into the connecting portion 404A, water surface tension will prevent condensed water in the sensing cavity 414 from draining back into process stream. Furthermore, the bore 420 diameter is preferably sufficiently large (e.g., at least 10 mm diameter, such as 12 to 20 mm diameter) to permit the water drainage and fresh gas access to the sensing membrane 412.

In one embodiment, one or more heat sink fins 428 are located on an outside wall of the connecting portion 404A. In one embodiment, the transducer portion 402A is a separate element from the connecting portion 404A having separate sidewalls, and the transducer portion 402A is connected to the connecting portion 404A by threads 430 or another fastener. In an alternative embodiment, the transducer portion 402A and the connecting portion 404A comprise portions of a unitary pressure sensor 400 having a continuous outer sidewall.

In one embodiment, the pressure sensor also includes a venturi 406 in fluid communication with the connecting portion 404A. The venturi 406 includes an inlet portion 406A, a converging portion 406B, a throat portion 406C and a diverging outlet portion 406D. In one embodiment, the connecting portion 404A is in fluid communication with (i.e., fluidly connected to) the throat portion 406C of the venturi 406. In another embodiment, the connecting portion 404B is in fluid communication with the inlet portion 406A of the venturi 406. In another embodiment, the pressure sensor 400 includes two connecting portions 404A and 404B in fluid communication with two respective transducer portions 402A and 404B. The first connecting portion 404A is in fluid communication with the throat portion 406C of the venturi 406 and the first transducer portion 404A, while the second connecting portion 404B is in fluid communication with the inlet portion 406A of the venturi 406 and with the second transducer portion 404B having a respective sensing diaphragm 412. The inlet portion 406A of the venturi is connected to a first portion of a conduit (e.g., the anode exhaust conduit 308 of the SOFC system or a water recycle conduit of the SOEC system), and the diverging outlet portion 406D of the venturi 406 is connected to a second portion of the conduit 308.

In various embodiments, an electrochemical system includes an electrochemical stack and the pressure sensor 400. In one embodiment, the electrochemical system comprises fuel cell system 10 in which the electrochemical stack comprises a fuel cell stack 102, and the fuel cell system further comprises an anode exhaust conduit 308 configured to receive an anode exhaust from the stack 102 and located in fluid communication with the connecting portion 404A (e.g., via the venturi 406) of the pressure sensor 400. In another embodiment, the electrochemical system comprises an electrolyzer system in which the electrochemical stack comprises an electrolyzer stack.

In one embodiment, an axis extending through the centers of the transducer portion 402A and the connecting portion 404A is inclined by an angle of 30 to 60 degrees, such as 40 to 50 degrees, for example 45 degrees relative to a bottom of the electrochemical system (i.e., relative to the ground and to the direction of the force of gravity).

The preceding description of the disclosed aspects is provided to enable any person skilled in the art to make or use the present invention. Various modifications to these aspects will be readily apparent to those skilled in the art, and the generic principles defined herein may be applied to other aspects without departing from the scope of the invention. Thus, the present invention is not intended to be limited to the aspects shown herein but is to be accorded the widest scope consistent with the principles and novel features disclosed herein.

1. A pressure sensor, comprising:
a transducer portion comprising a pressure sensing diaphragm; and
a connecting portion having a first end in fluid communication with the transducer portion and a second end located opposite to the first end, wherein:
the connecting portion comprises a bore having an outlet and a stepped inlet;
the outlet is located closer to the first end than the stepped inlet;
the stepped inlet comprises a first surface having a gas opening and a second surface having a water opening; and
the first surface is located closer to the first end than the second surface.

2. The pressure sensor of claim 1, wherein:
the first surface is located farther from the second end than the second surface; and
the second surface is located farther from the first end than the first surface.

3. The pressure sensor of claim 1, wherein:
the outlet is located farther from the second end than the stepped inlet; and
the stepped inlet is located farther from the first end than the outlet.

4. The pressure sensor of claim 1, wherein the transducer portion further comprises a sensing cavity located adjacent to the pressure sensing diaphragm, and an inlet conduit which fluidly couples the sensing cavity to the bore of the connecting portion.

5. The pressure sensor of claim 1, wherein the transducer portion is connected to the connecting portion by threads.

6. The pressure sensor of claim 1, wherein the transducer portion and the connecting portion comprise portions of a unitary pressure sensor having a continuous outer sidewall.

7. The pressure sensor of claim 1, further comprising a heat sink fin located on an outside wall of the connecting portion.

8. The pressure sensor of claim 1, further comprising a venturi in fluid communication with the connecting portion.

9. The pressure sensor of claim 8, wherein the connecting portion is in fluid communication with a throat portion of the venturi.

10. The pressure sensor of claim 8, wherein the connecting portion is in fluid communication with an inlet portion of the venturi.

11. The pressure sensor of claim 8, further comprising a second connecting portion in fluid communication with a throat portion of the venturi and a second transducer portion comprising a second pressure sensing diaphragm in fluid communication with the second connecting portion.

12. The pressure sensor of claim 8, wherein an inlet portion of the venturi is connected to a first portion of a conduit and a diverging outlet portion of the venturi is connected to a second portion of the conduit.

13. The pressure sensor of claim 1, wherein the stepped inlet further comprises a sidewall which extends from the first surface to the second perpendicular to the first surface and to the second surface.

14. An electrochemical system comprising an electrochemical stack and the pressure sensor of claim 1.

15. The electrochemical system of claim 14, wherein:
the electrochemical system comprises fuel cell system in which the electrochemical stack comprises a fuel cell stack; and
the fuel cell system further comprises an anode exhaust conduit configured to receive an anode exhaust from the stack and located in fluid communication with the connecting portion.

16. The electrochemical system of claim 14, wherein the electrochemical system comprises an electrolyzer system in which the electrochemical stack comprises an electrolyzer stack.

17. The electrochemical system of claim 14, wherein an axis extending through a center of the transducer portion and a center of the connecting portion inclined by an angle of 30 to 60 degrees relative to a bottom of the electrochemical system.

18. A method of operating the pressure sensor of claim 1, comprising:
providing a process gas from the gas opening through the bore to the sensing membrane; and
draining a condensed water from the sensing membrane through the bore and through the water opening.

19. The method of claim 18, wherein the process gas generates a pressure differential on the condensed water which allows the condensed water to drain through the bore and through the water opening.

20. The method of claim 18, wherein the process gas comprises an anode exhaust stream from a fuel cell stack or steam from a water recycle stream of an electrolyzer stack.
